(19) United States
(12) Patent Application Publication
(10) Pub. No.: US 2011/0307401 A1
(43) Pub. Date: Dec. 15, 2011

(54) PEOPLE RELATIONSHIP MANAGEMENT SYSTEM

(76) Inventor: ROY ALTMAN, New City, NY (US)

(21) Appl. No.: 12/814,058

(22) Filed: Jun. 11, 2010

(51) Int. Cl. G06Q 10/00; G06F 17/30

(52) U.S. Cl. 705/320; 705/348; 707/736

(57) ABSTRACT

A People Relationship Management system for an organization having multiple assets each identified by organization meta-data, the system having a management repository for storing connected spheres in a multi-dimensional model. The management repository includes virtual items, business rules and contexts and the model includes both hierarchical and peer-to-peer connections among the spheres. Each sphere contains information in the form of sphere data about a selected asset or a group of selected assets in both hierarchical and peer-to-peer relationships between the spheres. At least one current asset information repository is connected to the management repository and contains dynamically updated meta-data about the assets, the management repository periodically pulling the updated meta-data from the asset information repository to update and render current the asset information of each sphere.

### FIELD AND BACKGROUND OF THE INVENTION

The present invention relates generally to the field of Information Technology that leverages human resource (HR) information, and in particular to a new and useful system and software for creating and maintaining relationships between workers, or other assets, within an organization or along the extended value chain, and storing such information in a centralized repository intended to feed all other systems and processes that need that information.

U.S. Pat. No. 6,067,548 to Cheng discloses a dynamic organization model and management computing system that provides a dynamic organizational database as an underlying information system to support collaborative computing in a global enterprise. The information system is built based on the Organizational Modeling and Management model (OMM) and provides a system architecture and a graphical user interface for easy manipulation of organizational objects. The invention disclosed in the present application is an improvement on this prior art. Whereas in Cheng the relationships (virtual links) are resolved at runtime, in the present invention, they are resolved at the time defined, and adapted when changes to the information that defines the organizing principles is changed. Runtime resolution is extremely inefficient for complex structures and relationships. This improvement of this invention provides a method for quick, efficient retrieval at runtime. Additionally, Cheng only supports owner-member relationships, whereas the present invention supports peer-to-peer relationships as well. The purpose of Cheng is to provide relationship information for use in a Business Process Management (BPM) system, whereas the present invention provides flexible groupings of employees or other company assets for assigning automated business rules that are not necessarily for use with workflow systems.

The inventor of the subject application has recognized that a need exists for improving the way in which personnel and other company information is collected and accessed. See his following articles:

“Organization Modeling Aligning Relationships, Boosting Enterprise Effectiveness,” Altman, January 2007.

“Organization Modeling for the Real World,” Altman, February 2008.

“People Relationship Management—Completing the BPM Value Proposition,” Altman, June 2009.

“Enterprise Process Automation—Providing the Gift of Time,” Altman, Expected June 2010.

A need remains for the subject invention which, for the first time provides a system and software for maintaining relationships in multiple contexts, effectively creating a multi-dimensional organizational model, and creating flexible groupings of employees and other company assets.

### SUMMARY OF THE INVENTION

It is an object of the present invention to provide a People Relationship Management system that provides a repository for storing spheres, relationships, business rules and associated information, effectively creating a multi-dimensional model of the organization. Business rules based on company metadata define the organizing principles of the company's information, as well as enforcing desired behaviors. The spheres and relationship information is kept up-to-date by being able to sense changes in the information that define the spheres and relationships, and rebuild themselves as appropriate.

Without the invention, an alternative might be to build a custom computer application for each instance that requires business rules to define sub-sets of the employee population. Multiple organization structures to accommodate each application would not be sensitive to human resource transactions, and therefore get out of sync. In addition, in transitional systems, relationships are always assigned on a person-to-person basis. This is arduous to maintain. The subject invention however, allows flexible relationships, such as: I am the manager of my project team, my boss is the manager of his department, and his boss is the manager of the business unit. Inclusion in any of the units of, for example, “project team,” “department” or “business unit” will automatically maintain the reporting relationship according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic representation of the architecture of the system and software of the present invention;

FIG. 2 schematically illustrates the relationship structure of the invention in its most elemental form;

FIG. 3 is a schematic illustration of a simple hierarchy that the invention is capable of;

FIG. 4 is a schematic illustration of a peer-to-peer structure the invention is also capable of;

FIG. 5 illustrates a multi-dimensional, organization structure that is possible by practicing the subject invention;

FIG. 6 shows a broken tree structure that can be avoided when necessary by the invention;

FIG. 7 shows a circular reference that can be avoided by the invention;

FIG. 8 illustrates a relationship example according to the subject invention;

FIG. 9 illustrates a base level sphere of the invention;

FIG. 10 shows nested spheres according to the invention;

FIG. 11 illustrates a business rule sphere of the invention;

FIG. 12 shows the relational data model of the invention;

FIG. 13 shows the process flow for defining a virtual item;

FIG. 14 illustrates the process flow and means for defining a business rule;

FIG. 15 illustrates the process flow and means for defining a sphere;

FIG. 16 illustrates a process and means by which the invention adapts inclusion in spheres based on changes to demographic information;

FIG. 17 illustrates the process and means by which an external application would consume the relationship information from the repository;

FIG. 18 illustrates an example of the invention that showing all relationships that a person in the example participates in;

FIG. 19 illustrates the person's relationship participation from the person's view point; and

FIGS. 20, 21, 22, 23a, 23b, 24, 25, 26a and 26b illustrate various steps, processes or screen shots of an embodiment of the invention.

### DESCRIPTION OF THE PREFERRED EMBODIMENTS

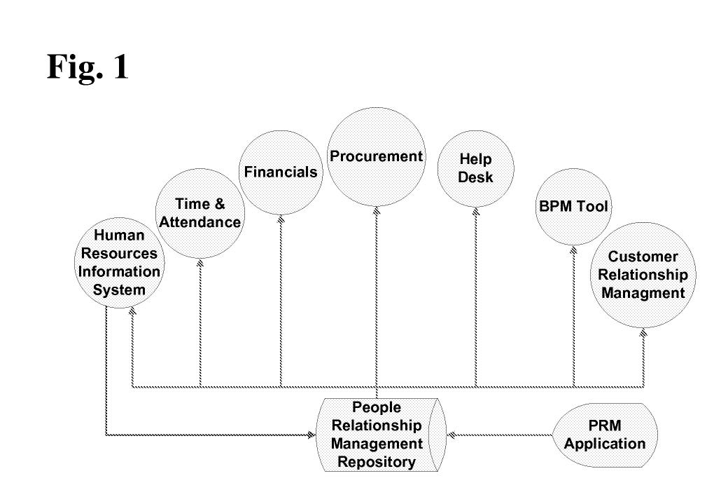

Referring now to the drawings, FIG. 1 shows the overall architecture of the system and software arrangement of the invention. In FIG. 1 the people relationship management system of the invention is shown to have a management repository for storing a plurality a spheres. The terms spheres, virtual items and business rules will be more fully explained later in this disclosure. At least one resource information module, such as a human resources information system, is connected to the repository for periodically updating, e.g. every night, the sphere data, and adjusting inclusion of spheres within other spheres according to the execution of business rules. A People Relationship Management application is used to configure the virtual items, business rules, spheres and relationships.

### Multiple Structure Types:

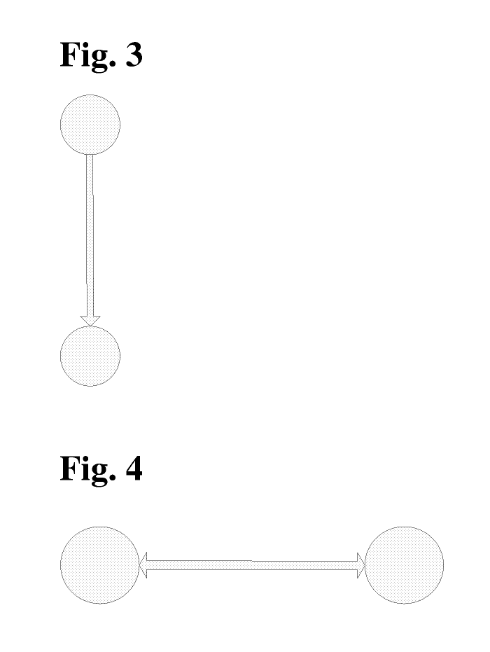

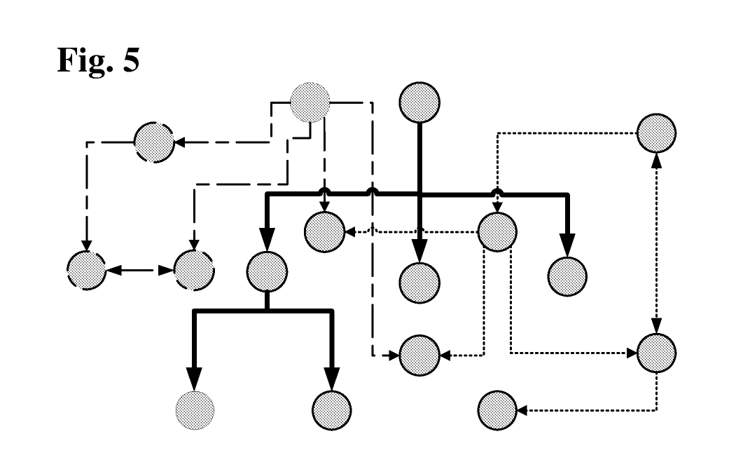

The present invention is able to represent relationships in a hierarchical matrix schematically shown in FIG. 3, and peer-to-peer structures illustrated by FIG. 4. FIG. 5 schematically illustrates the capacity of the inventive system and software to maintain relationships in multiple contexts by effectively creating a multi-dimensional organizational model.

### Validates Relationships:

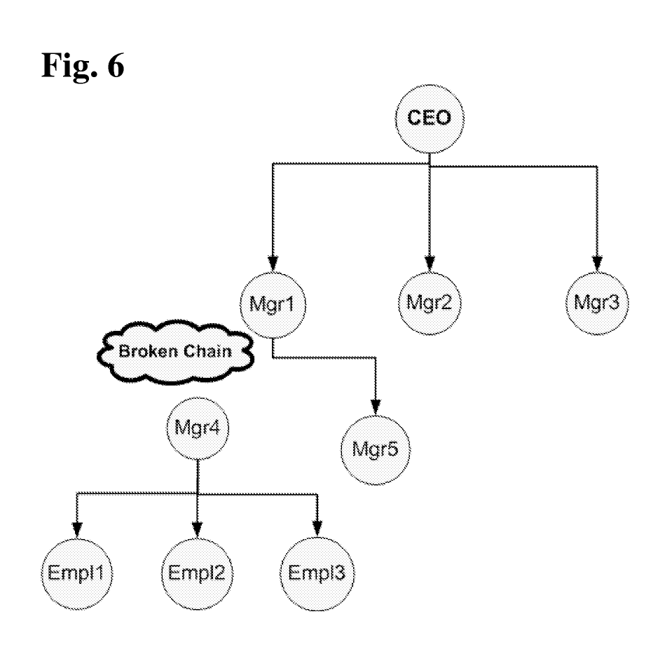

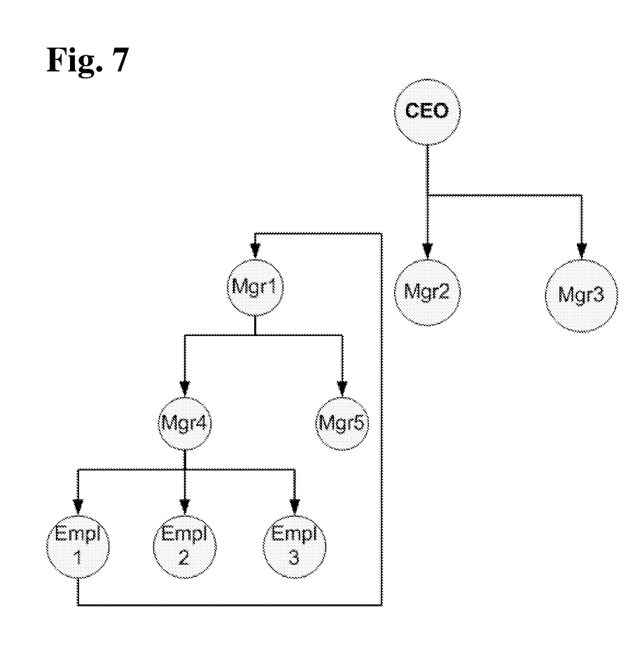

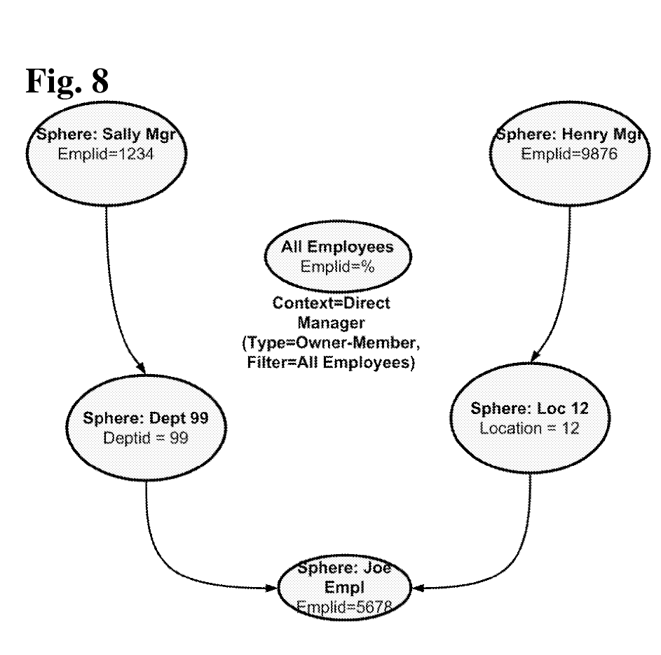

The people relationship management solution of the invention validates that critical contexts are compliant as a fully articulated tree structure. A fully articulated tree structure is one in which any node in the tree can be traced upward to the root node, without any undesired breaks as shown in FIG. 6 or undesired circular references shown in FIG. 7. The invention is sensitive to daily HR transactions, e.g. new hires, terminations, transfers, etc., that would break the fully articulated tree structure. The invention moves all nodes up in order to remain compliant, and notifies a responsible party to make the proper adjustments in a timely manner. This process is here referred to as “self-healing.”

### Organization Modeling:

The invention also applies rule-based criteria for assembling workers into groups that have similar reporting relationships. In this way, movement within the organization is self-maintaining by consistently applying the rules. In order to accomplish this, it is helpful to leverage the meta-data layer of the Human Capital Management system in order to dynamically construct and enforce the rules. To achieve this, there are two other concepts in addition to multiple contexts, stated above.

### Spheres:

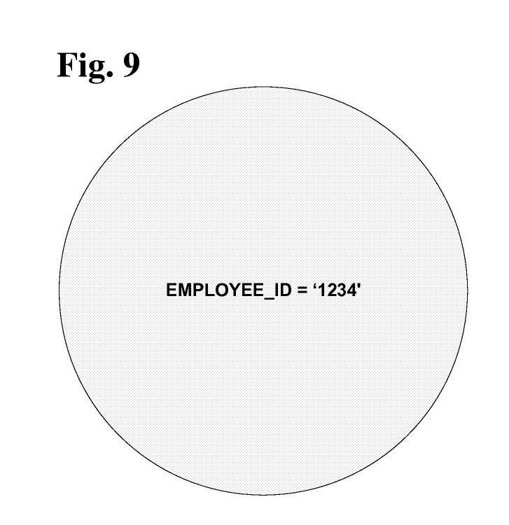

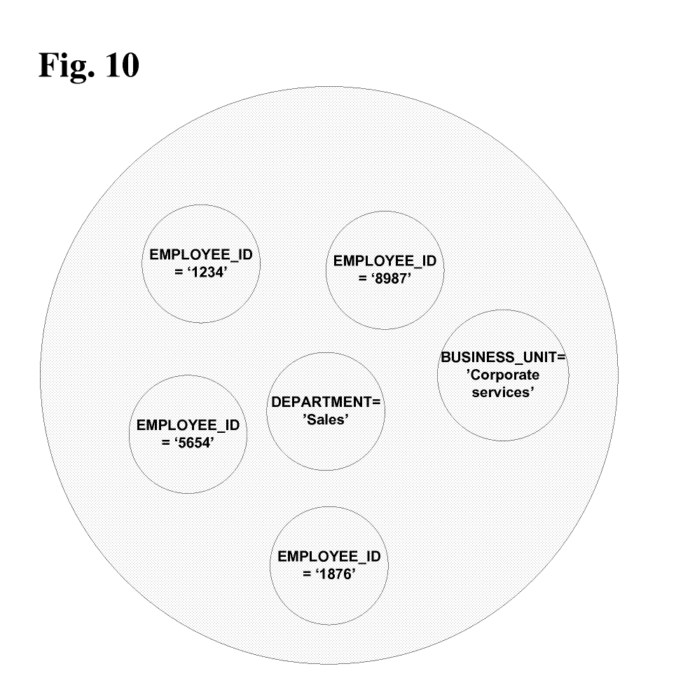

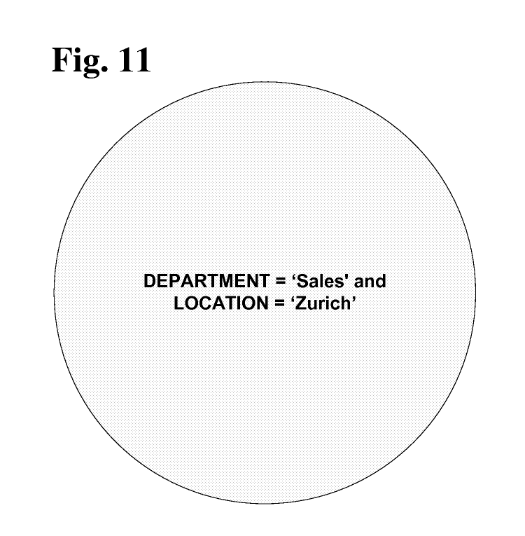

A sphere, in the context of the present disclosure, is a collection of assets, most commonly: workers. The most elemental is the employee. Each employee is, by default, its own sphere. However, spheres can be ad hoc groups of individual employees (such as a project team), or it could have an organizing principle enforced by rules (i.e., all salesmen in the Düsseldorf office). These rules leverage the meta-data layer of the data model in order to have maximum flexibility as illustrated in FIG. 11. For example, a rule says that all managers within a particular location belong to the same sphere, or all non-exempt employees in the same department, one can enforce that by dynamically creating the criteria using the data items and operators needed. If a sphere is rule based, it is self-maintaining. Spheres can be nested as shown in FIG. 10, to create complex macro-structures, as a company's maturity with the process grows. Spheres do not necessarily need to refer to human assets. The sphere can be a server in an IT support desk function. One can assign a sphere of servers to the IT technician assigned to support them, so that outage requests are directly routed to the correct person for the server that needs attention. A base-level sphere, the most granular sphere, is depicted in FIG. 9.

Nested spheres essentially creates a bill-of-materials structure of humans. Bill-of-materials structures are commonly used in manufacturing applications to keep track of many levels of sub-assembly. This essentially creates an n-level hierarchy, where n can be any number. The present invention is the first instance where software is used to create a bill-of-materials structure of humans, so that any complex arrangement can be represented and traversed efficiently.

### Business Rules:

Business rules can be assigned to spheres, for instance, to require that the rules in a collective bargaining agreement apply to all members of the sphere containing those union members. Business rules can leverage meta-data. For instance: DEPARTMENT=‘1234’, or LOCATION=‘NY’. A business rule can alternatively be computer code, such as the enforcement of a fully-articulated tree structure. A business rule could be applied to a sphere, or to a context.

### Contexts/Spheres/Business Rules:

The present invention is, in effect, brought to life by combining contexts, spheres and business Rules. The basic structure is two spheres connected in a context, with the business rules of each enforced. However, spheres can filter contexts as well. For example, the context of “Union Reporting Structure” is only relevant to people in the “Union” sphere, so this context will only be available to those within that sphere. Business rules from contexts or spheres are inherited when spheres and contexts are combined. When they conflict, the user will be given the choice as to how to resolve the conflict. Through the interaction of contexts, spheres, and business rules, very flexible models of the organization are achievable in very dynamic ways.

### Virtual Item:

Each data item in the system is a virtual item, meaning that it may not be an actual data item. A virtual item may refer to an employee-specific piece of data, such as EMPLOYEE_ID, whereby the information returned would be the EMPLOYEE_ID of each person. Or it may be a literal, such as JOES_EMPLOYEE_ID=‘1234’. Or it could be the result of a function or web service. This means that the system of the invention need not store all of the information that it needs, but needs a way of accessing that information remotely. However, virtual items are what are used to create business rules. Thus as interconnectivity between systems increases, the invention leverages information anywhere in the construction of rules.

### Run-Time Execution:

Prior art software resolves the relationships at run-time. This means that if one needs to access a person's direct reports, the system navigates to the direct reports and retrieves them when it needs them. Since the relationships are very simple, this makes sense. However, the present invention supports much more complex relationships, based on nested groups and business rules, so it would be technically inefficient to resolve this at run-time. This problem is mitigated by resolving the relationships at setup time. For instance, once a sphere is created or modified, the system will decompose the sphere into its most granular form and store it in the database. At runtime, the system just needs to retrieve the granular information that is stored. This can be retrieved quickly if the database structure is tuned for performance. This scheme presupposes that any modification to a worker's data, if it is a data item that is significant for a business rule that defines a sphere, will cause the sphere to be re-decomposed into its granular form. For instance, if a sphere exists based on the rule “DEPARTMENT=‘Sales’”, and another one based on the rule “DEPARTMENT=‘Marketing’” and an employee transfers from Sales to Marketing, the system will detect the transfer and rebuild the ‘Sales’ and ‘Marketing’ spheres in the database. During runtime, if there is a need to retrieve the ‘Sales’ sphere, all of the elemental spheres are already in place.

### Relational Model:

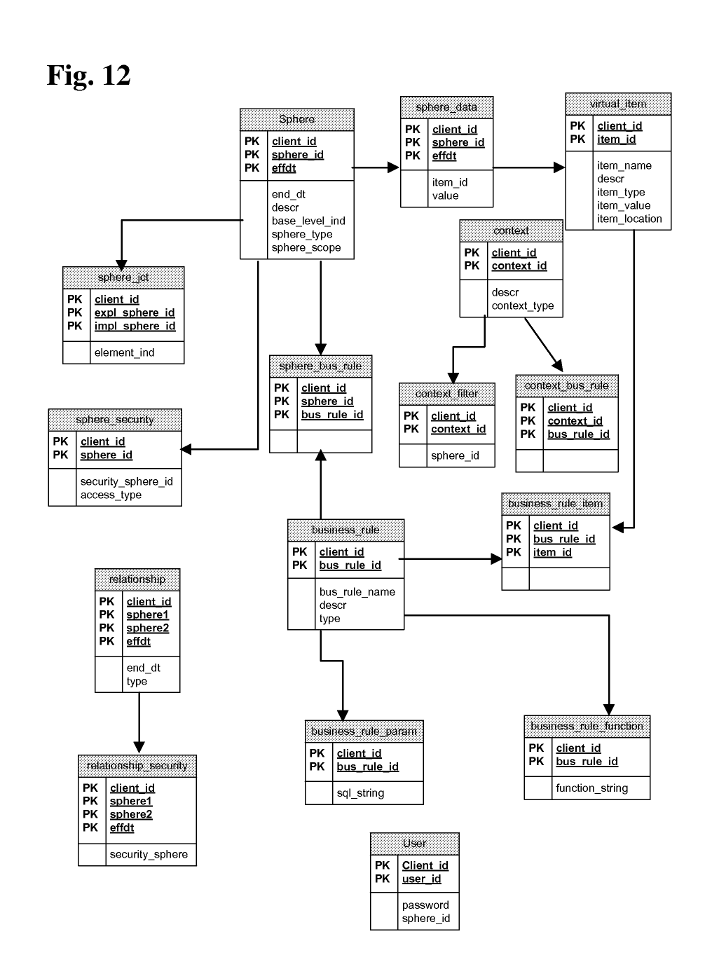

The invention is heavily dependent on the relational data model in order to realize it's advantages. FIG. 12 is an Entity-Relationship model diagram. The following sections on use cases will reference objects within this model.

### Use Cases:

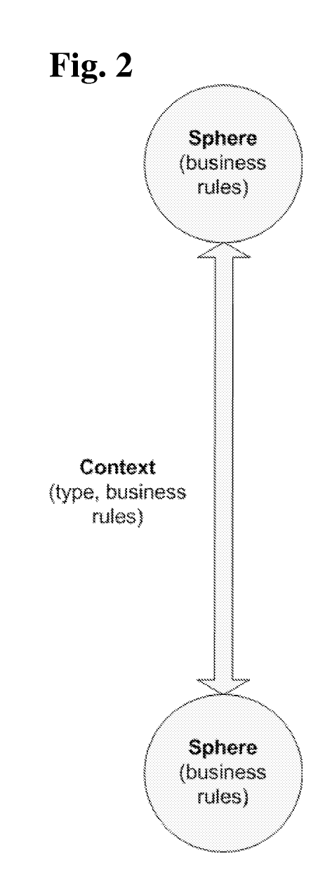

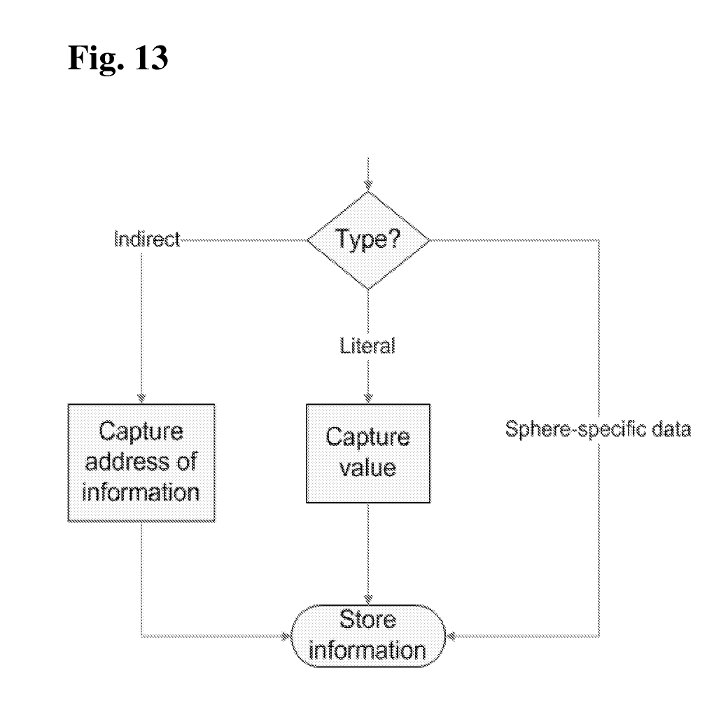

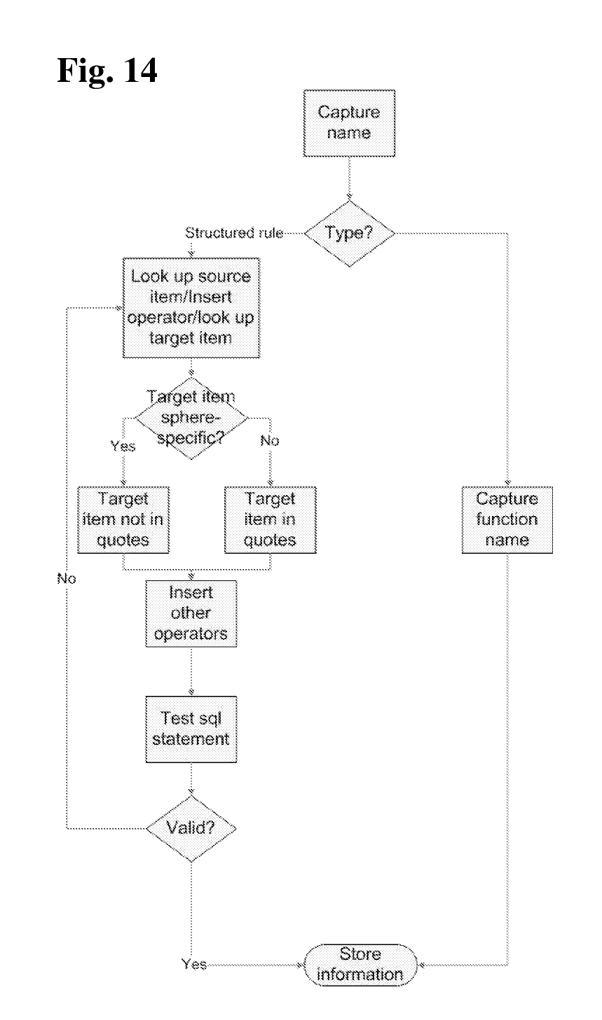

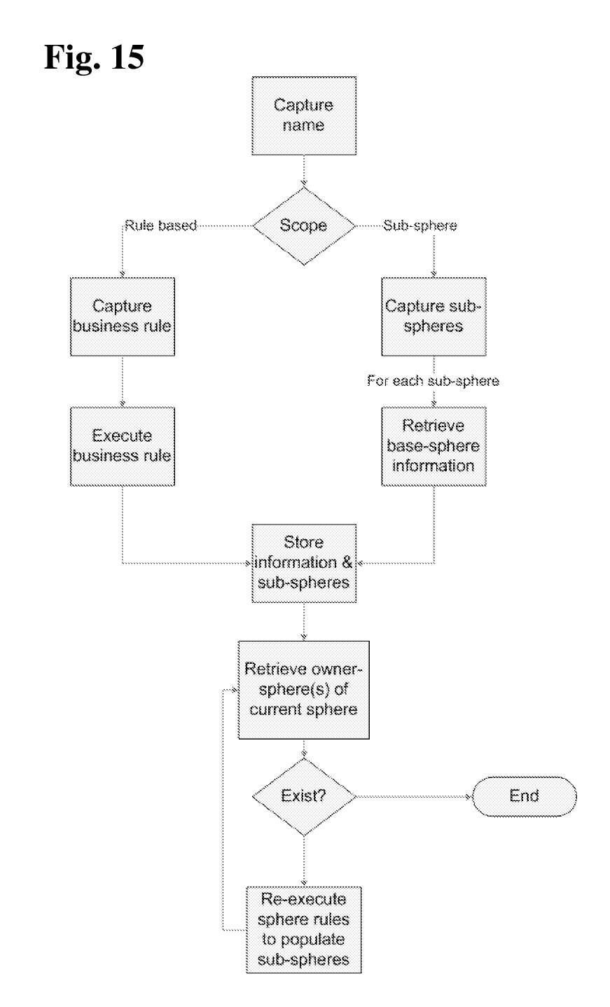

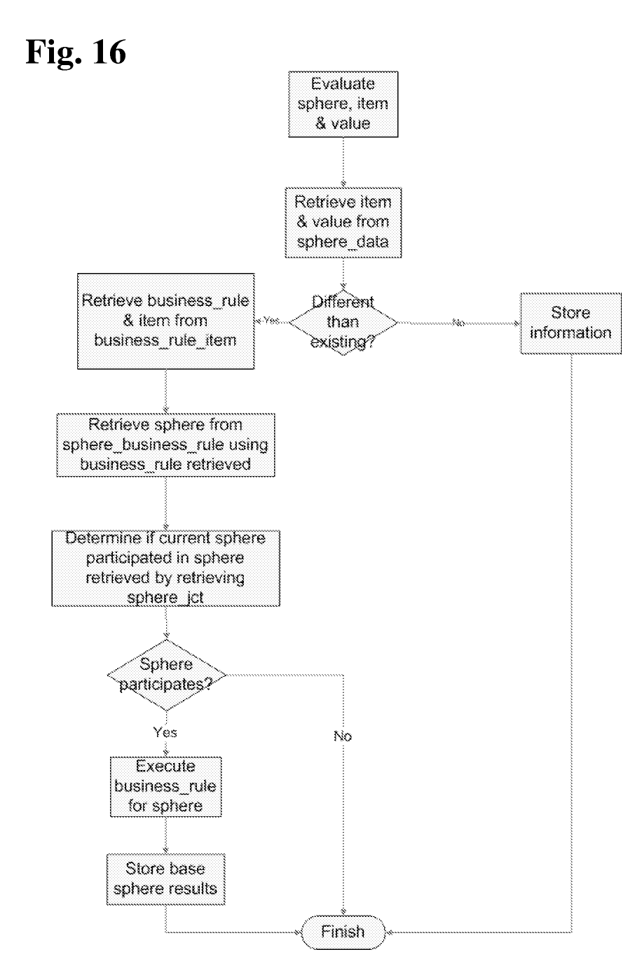

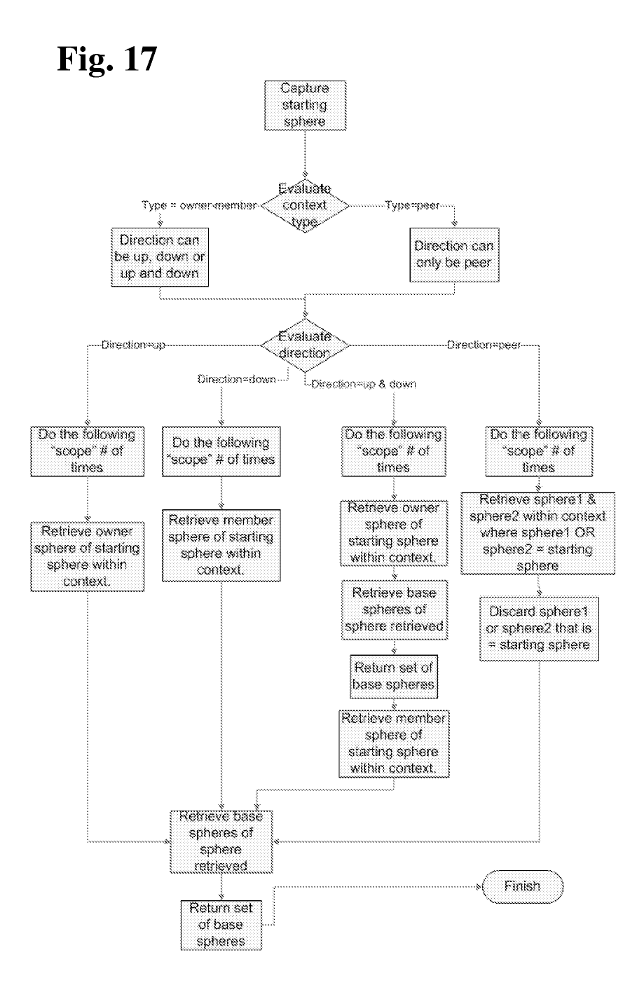

There are three use cases involved with this invention:
Configuring the structure
   Configuring the relationships in the organization involves the following steps:
      Define Contexts
      Define Virtual Items FIG. 13
      Define Business Rules FIG. 14
      Define Spheres FIG. 15
      Define Relationships FIG. 2
Maintaining the structure:
   Sensitive to changes in demographic information FIG. 16
Consuming the information
   getPerson function FIG. 17.

### EXAMPLE

Wonderful Widgets, Inc. is a multinational company that makes software products. Their financial structure is arranged by Business Unit. Organizationally, they are a use a matrix-management structure. The HR structure is by department within location, yet employees are assigned to projects which can consist of participants from around the globe. In addition, the company supports interest groups for collaborative efforts and local team-building activities.

Arthur Architect is a software architect working in the US Headquarters. He is part of the Global Software Development business unit. Carlos Comptroller signs off on the P&L sheets of that business unit. Arthur is part of the US Technical department, which is managed by the EVP of US Technical Resources, Evan Executive. Arthur's direct report is the manager of US Architecture, Sally Supervisor. Arthur is currently assigned to Project Parsimonious, which is managed by Marilyn Manager. She handles day-to-day issues like approving timesheets and vacation requests. Arthur's performance review is done by Sally, in conjunction with Marilyn, and any other project manager Arthur worked for during the course of the year. Arthur is also the captain of the US headquarters Bowling Team. He is part of the Global Architects interest group, in which he and other architects share tips & techniques. The Global Architects group is part of a web-based network of professional architects.

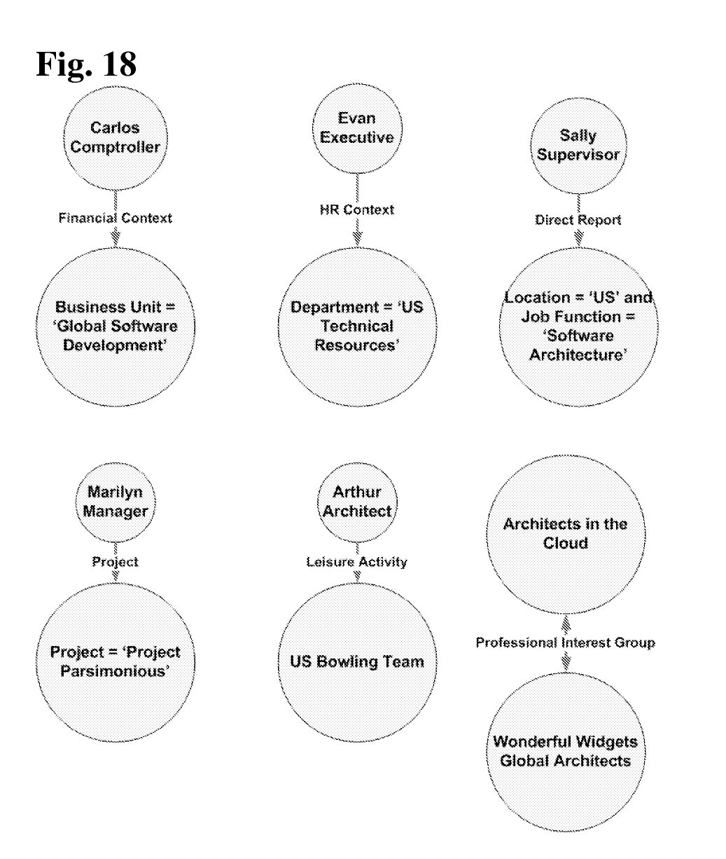

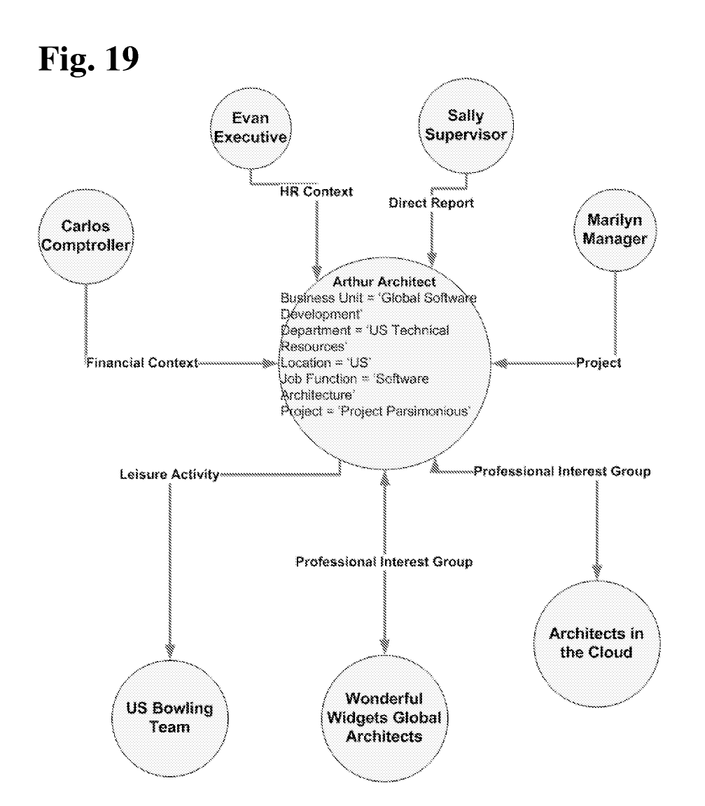

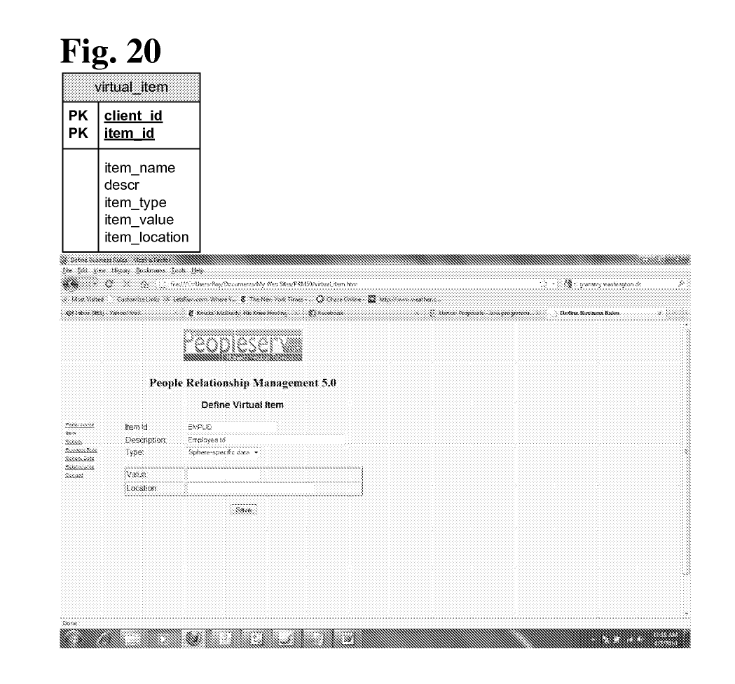

As a result, Arthur participates in all of the following relationships, as shown in FIG. 18. From Arthur's point of view, his relationships look as shown in FIG. 19.

The system exports the Project relationship to the Time & Attendance system. This way, when Arthur submits a timesheet for approval, or requests a vacation, it is routed to Marilyn, not Sally who doesn't manage him day-to-day. However the Performance Management system would export both the relationship with Sally and with Marilyn, because they would both have input into his performance review. Arthur writes a newsletter for the US Bowling Team. The newsletter uses the US Bowling Team sphere as the distribution list. The Global Architects have a blog. Only those in the Global Architects sphere have access to the blog. If Arthur needs to purchase an expensive software product, the purchase requisition must be sent to the Department EVP for approval. Thus the Procurement system exports the Department relationship so that the requisition would be approved by Evan. If Arthur transfers to the London Technical Resources department, managed by Trevor, and Arthur purchases the same software product, the Procurement system would route the requisition to Trevor, not Evan, because the PRM system would recognize the transfer and automatically establish Arthur as part of the London Technical Resources department. This is because of the following of the business rules and the updated resource information module that periodically, e.g. every night, provides is updated information to the management repository of connected spheres in the multi-dimensional model of the invention.

FIG. 12 is an Entity-Relationship diagram of the Logical Data Model on which the application and invention is based. Each box represents a database record identified by the name in the top bar of the box. Each item in the box represents a data item within the database record. Those preceded with a “PK” indicate that those data items are part of the primary key of the record. The lines with arrows between the boxes represents the data relationships between the records. The direction of the arrow indicates a one-to-many relationship. For instance, the record “Sphere” has a one-to-many relationship with “sphere_data.” The People Relationship Management software application is used to configure the information relationships in the schema represented by the Entity-Relationship diagram. Once the information is in that format, it can be used by consuming software applications to yield the intended results.

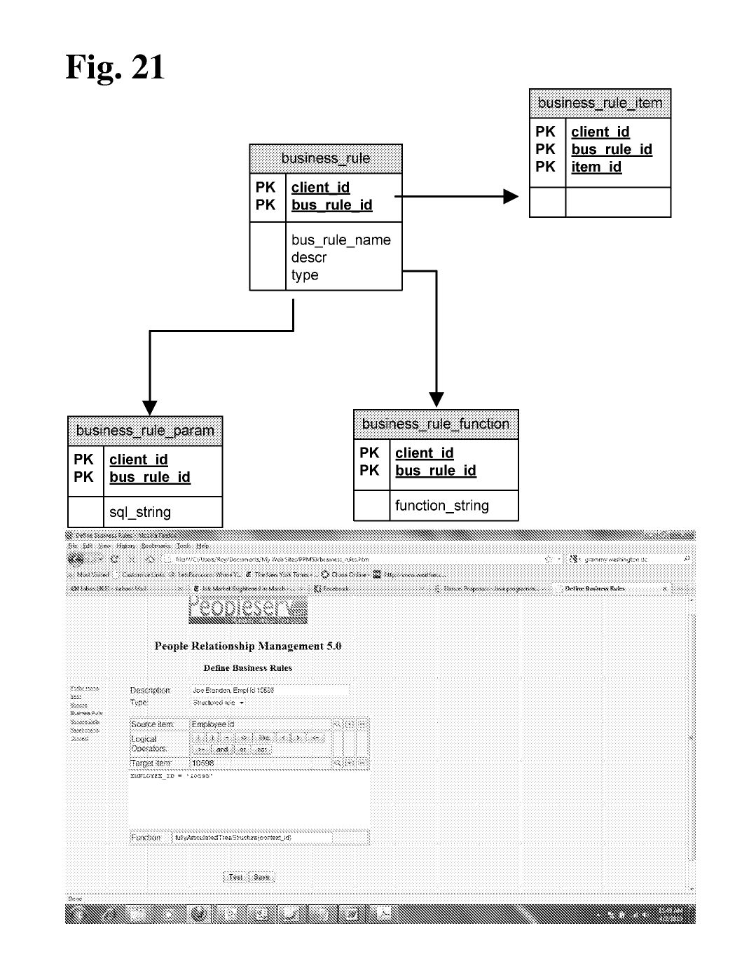

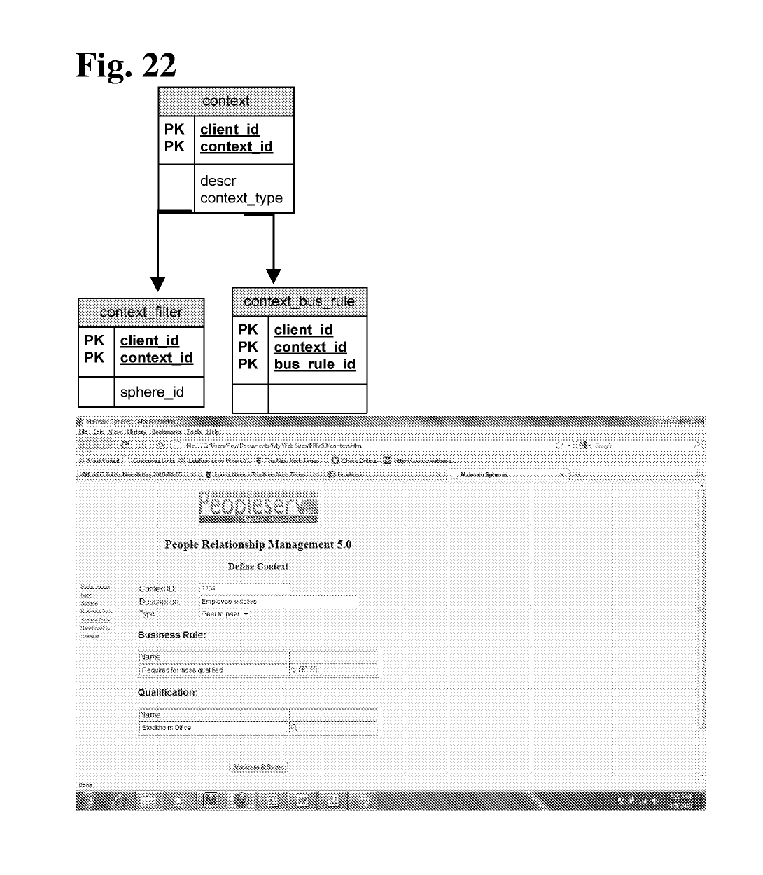

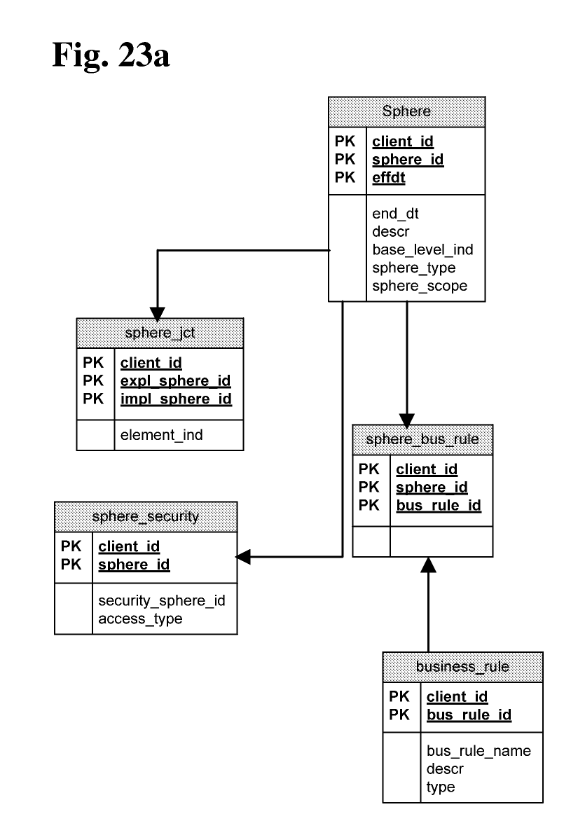

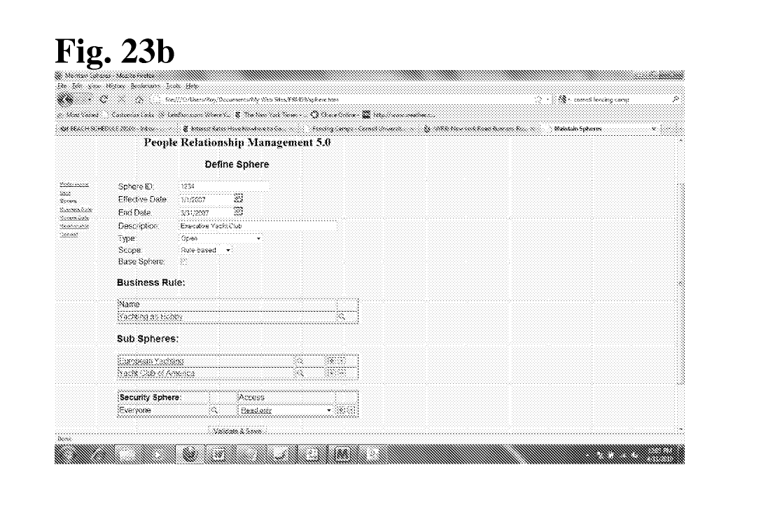

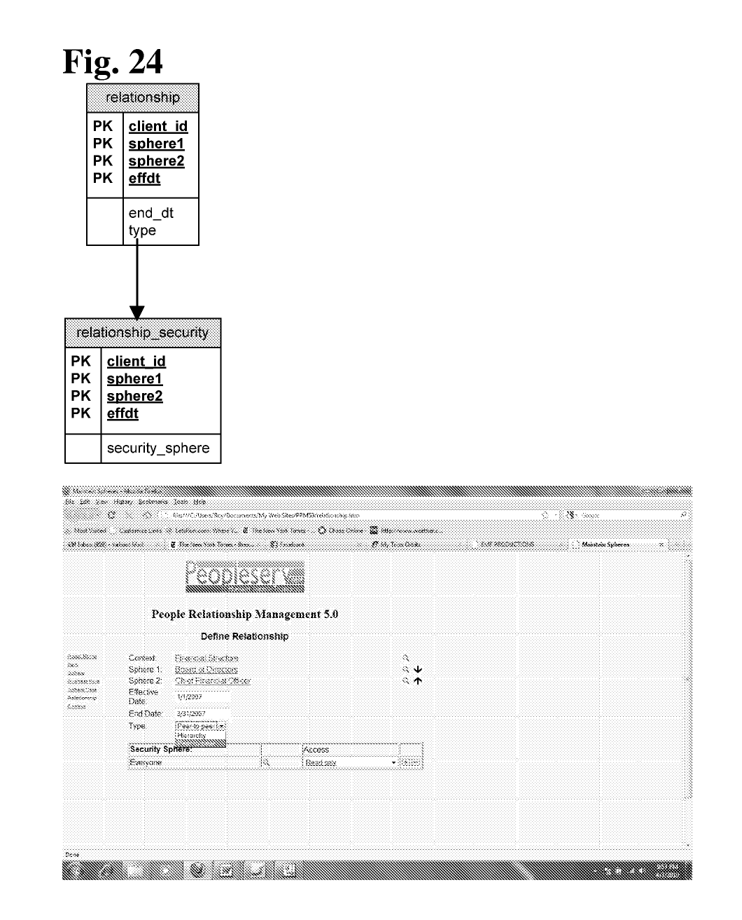

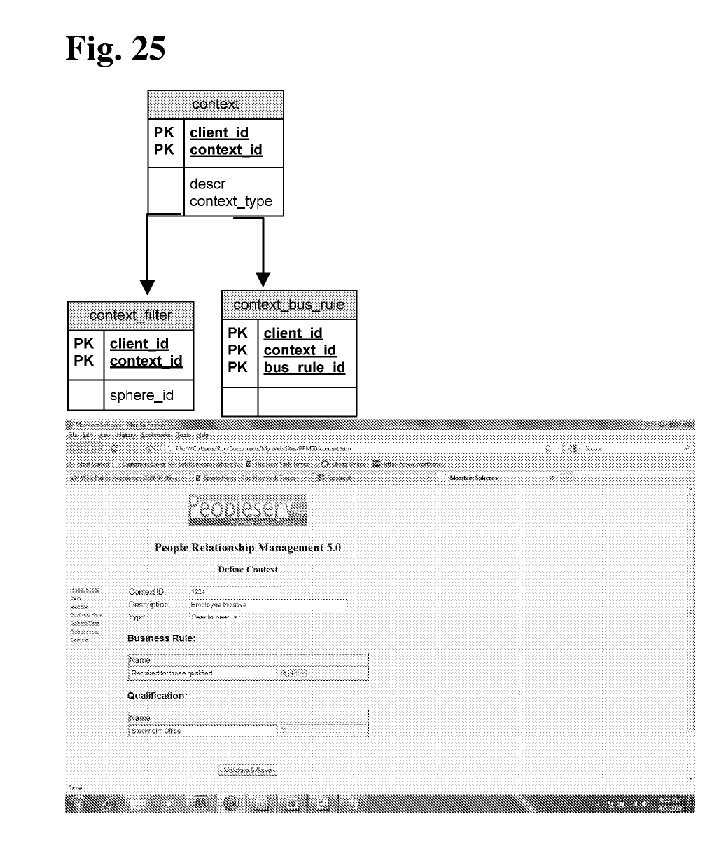

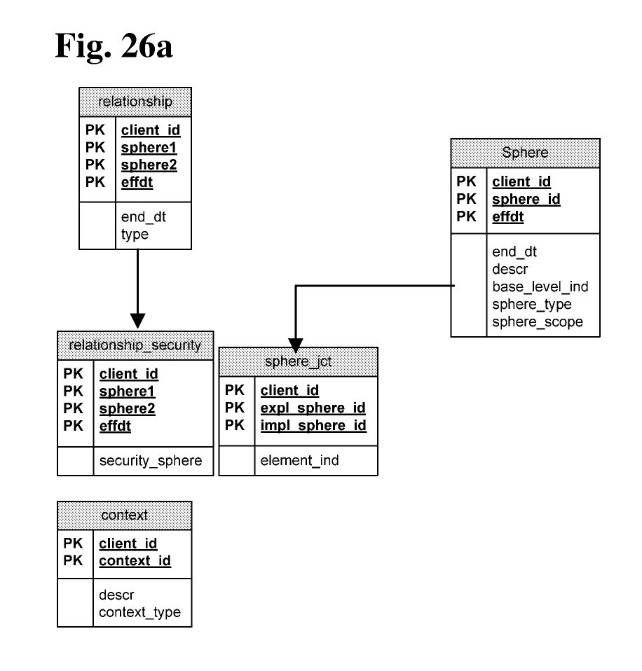

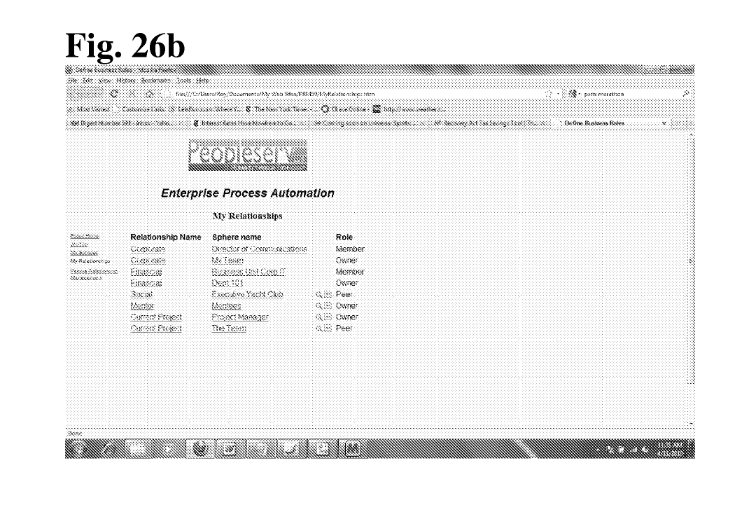

FIGS. 20, 21, 22, 23a, 23b, 24, 25, 26a and 26b illustrate sample pages used by an administration application in order to configure the organizing principles of the software application of the invention. These are examples of a specific implementation and not an exact representation of the pages required to configure the application. The entity relationship diagrams associated with the administration pages illustrates which database records the application is responsible for maintaining.

The invention defines relationship structure using “mix-and-match” criteria based on metadata. It defines relationship structure which can include human and non-human (hardware or software) assets. Virtual item, which can be:
Information related to an asset (based on meta-data)
Result of a coded function
Information that exists remotely, but can be accessed via integration technology.

Relationship structure is resolved into its most granular level at definition time (not execution time). Therefore, at execution time, the system only need be concerned with retrieving the information efficiently rather than resolving the relationships and the contents of the spheres participating in the relationships.

Relationship structure is self-maintaining if based on metadata and sensitive to changes in demographic information.

Enforces fully-articulated tree structure for mission-critical relationships.

The People Relationship Management system of the invention for an organization thus includes a management repository for storing a plurality of spheres, virtual items, business rules and contexts. The configuration of these elements comprises a relationship, virtual items that are indirection of addressing, nested spheres, e.g. bill-of-materials structure of humans, the ability to mix organizing principles within the same structure and to support a multi-dimensional organizational model that is “self-healing” in that it preserves a fully-articulated-tree-structure at all times. The invention supports both hierarchical and peer-to-peer structures within the same organization and has the ability to decompose into most granular form, ready for consumption, during set-up time, instead of run-time. The invention also has the ability to sense and react to changes in information that affects the organizing principles, and reorganize accordingly.

While a specific embodiment of the invention has been shown and described in detail to illustrate the application of the principles of the invention, it will be understood that the invention may be embodied otherwise without departing from such principles.

What is claimed is:

1. A People Relationship Management system for an organization having multiple assets each identified by organization meta-data, the system comprising:
a management repository for storing a plurality of connected spheres in a multi-dimensional model, the management repository including virtual items, business rules and contexts, the model including hierarchical and peer-to-peer connections among the spheres, each sphere corresponding to a selected asset or a group of selected assets of the organization, the spheres being organized by business rules that act on indicative information about the assets for both hierarchical and peer-to-peer relationships between the spheres;
at least one resource information module connected to the management repository, the resource information module containing records for employee indicative information; and
means for reorganizing spheres by reasserting the business rules when sensing changes in the employee indicative information, thus rendering the system sensitive to changes in the employee indicative information.

2. The People Relationship Management system of claim 1, wherein the information related to spheres includes personnel information on individual employees for the organization.

3. The People Relationship Management system of claim 1, including means for defining a business rule based on constructing and storing an sql statement in order to access meta-data as defined by virtual items.

4. The People Relationship Management system of claim 1, including means for defining a sphere by its business rule, at least some of the spheres comprising other spheres.

5. The People Relationship Management system of claim 1, including means for changing content of a sphere by recognizing a change in information that is significant to defining principle of a sphere, and means for updating the sphere and all other spheres affected by a change in information.

6. The People Relationship Management system of claim 1, including means for accessing spheres in relation to one another in the management repository.

7. The People Relationship Management system of claim 1, wherein the assets are at least one of: humans; objects of value to the organization; groups of employees; and groups of other assets.
